(19) United States
(12) Patent Application Publication
(10) Pub. No.: US 2007/0167176 A1
(43) Pub. Date: Jul. 19, 2007

(54) Management of the divert facility of a communication device

(76) Inventors: Timo J. Heikkinen, Tampere (FI); Petri Vetikko, Pirkkala (FI)

Correspondence Address: HARRINGTON & SMITH, PC, 4 RESEARCH DRIVE, SHELTON, CT, 06484-6212, US

(21) Appl. No.: 10/593,669

(22) PCT Filed: Apr. 27, 2005
(86) PCT No.: PCT/FI05/50135

§ 371 Date: Sep. 20, 2006

(30) Foreign Application Priority Data
Apr. 30, 2004 (FI) 20045160

(51) Int. Cl. H04Q 7/20

(52) U.S. Cl. 455/466; 709/206

(57) ABSTRACT

The invention relates to a method for managing, in a data communication network, communication addressed to a wireless communication device. The wireless communication devices communicating in the data communication network are equipped with at least one identifier (IMSI1-IMSI3) and in which, the communication device is equipped with a control feature of a divert facility, in order to control the divert facility concerning itself, and in which communication addressed to at least one communication device defined by a first identifier/identifiers (IMSI1) is routed at least partly to at least one communication device defined by a second identifier/identifiers (IMSI2). In the method the control feature of the divert facility of the communication device defined by the first identifier/identifiers (IMSI1) is remotely controlled using some second communication device.

The present invention relates to a method for managing, in a data communication network, communication addressed to a wireless communication device, in which the wireless communication devices communicating in the data communication network are equipped with at least one identifier and in which, the communication device is equipped with a control feature of a divert facility in order to manage the divert facility concerning itself, in which communication addressed to at least one communication device defined by first identifier/identifiers is routed at least partly to at least one communication device defined by a second identifier/identifiers. In addition, the invention also relates to a corresponding communication device, system, signal and program product.

The redirection of communication addressed to a wireless communication device equipped with a first identifier to a desired communication device equipped with a second identifier is known from the prior art. Such a divert facility can be managed, for example, using precisely the wireless communication device equipped with the particular first identifier, in which case it is equipped with the so called control feature of the divert facility. The management can take place, for example, by an established command being sent to the network component relaying communication in the data communication network, using the first device. In the command, such a second identifier is identified, to which it is wished to route the communication addressed to the first device in a set part and in an established manner. The other communication device may be a wireless communication device or a landline network device.

Due to the nature of the devices used as mobile stations, users may, however, sometimes forget or lose their own communication device. Along with the communication device, the identifier identifying the user in the network system, such as the SIM card, is also forgotten/lost. In such a situation, the user may get a replacement communication device in its place, which can be equipped with, for example, a SIM card of a corporate organization or similar. In corporations, such a totality is often referred to as a group data phone. The person who is its user may change even daily.

However, one significant drawback is associated with the practice referred to above. In such a situation, the mobile communication system still holds the information that the user can be contacted from their actual communication device. As a result, communication (for example, calls and SMS messages) addressed to the user's personal subscription identifier continue to be routed to this forgotten/lost device.

The known prior art for diverting communication addressed to a device equipped with a first identifier to some second device includes at least in the case of phone calls, an operator service. However, this requires an agreement with the operator. The performance of the shifting also requires the permission of the possessor of the subscription. The divert facility can be activated/deactivated, for example, by using the second communication device to call the operator's service number, where the diversion can be controlled.

However, significant difficulties are associated with communication redirection performed as such an operator service. They arise, for example, in the case of corporate subscriptions, in which the permission of a representative of the corporation may be required, in order to perform the diversion. There may be several diversions daily and, in addition, they may vary each day. In addition, diversions may have to be made at different times of the day. Further, it is necessary to remember to deactivate the diversion, once the user has got their own mobile station back. This operation too has a tendency to be forgotten. In addition to corporate subscriptions, diverting communication addressed to private subscriptions by using another subscription is reasonably difficult, indeed even impossible, without a separate operator-specific service agreement.

Further, some operators' divert facilities only concern phone calls. In that case, for example data messages, such as SMS messages, addressed to the communication device, will continue to be routed to the forgotten/lost device. All in all, the totality relating to the divert facility is at present highly operator-centred, which causes unreasonably difficulties for the end-users of the wireless devices.

As the prior art a reference is made to U.S. Pat. No. 6,151,503 and FR-patent publication 2 823 939. These both provides the operator oriented diversion service described above in order to be implemented in wireless communication. In the solution provided by U.S. Pat. No. 6,151,503 the forwarding of the wireless communication may be managed from the other device. In that case the control measures are objected to the network element being in the wireless network system. FR-2 823 939 brings about a divert service that is a helpdesk type.

The both solutions presented above are, however, very cost intensive and also strongly operator bonded. All operators don't even necessary bother to implement the solutions known from the publications, although there would not even be large obstacles to be solved in order to their technical implementation. This creates a clear usability problem for a flexible management of the services in question.

The present invention is intended to create a new type of method for managing the divert facility of a wireless communication device, by means of which the divert facility can be managed substantially more easily and simply, compared to the known solutions. Further, the invention is intended to also create a corresponding wireless communication device and system, by means of which the divert facility can be easily managed. The characteristic features of the method according to the invention are stated in the accompanying of Claim 1 and the characteristic features of the communication device applying the method are stated in Claim 8. In addition, the invention also relates to system, program product, subscriber identity module and signal, the characteristic features of which are stated in the accompanying Claims 13, 17, 21 and 22.

In the method according to the invention is performed controlling, in a data communication network, communication addressed to a wireless communication device, in which the wireless communication devices communicating in the data communication network are equipped with at least one identifier and in which communication device is equipped with a control feature of a divert facility in order to control the divert facility concerning itself, in which communication addressed to at least one communication device defined by a first identifier/identifiers is routed at least partly to at least one second communication device defined by a second identifier/identifiers. In the method the control feature of the divert facility of the communication device defined by first identifier/identifiers is, in a surprising manner, remotely controlled using some second communication device.

Remote controlling can take place in several different ways and the operations defined in it can be executed at several different points in a data communication network. The execution of control can be initialized using surprisingly the communication device itself that is the object of the divert facility.

According to one embodiment, remote control can be performed on the basis of an established data message, which can include various settings data. A first example of such settings data is authentication data. Authentication data can be used to ensure the validity of the remote controlling. In this way the control feature of the divert facility can be managed securely, and an advantage that it is possible, for example, to prevent possible interfering diversions.

A second example of settings data belonging in connection with a data message is identifier data. On the basis of identifier data the divert facility can, for example, be activated/deactivated to one or more destination communication devices defined by the identifier data. This will achieve, among other things, the advantage that the remote device managing the control feature of the divert facility need not necessarily be precisely the communication device, to which it is wished to address communication.

According to one embodiment, the communication device, or the data communication network can also include means, which are arranged to process the data communication addressed to the communication device, in a manner defined by a divert facility message. One example of this kind of processing is to relay the data message forward. Such a divert facility, which can even be implemented inside the device itself, reduces the dependence on the data communication network and on the operator operating there, while simultaneously permitting more extensive divert facilities that the prior art.

The invention permits a set-form of communication, for example, the diversion of phone calls/SMS messages easily and securely, for example, as a remote command in a data message. Another way to remotely control the divert facility is to arrange to the data communication network or to communication device a voice-robot service, for example, controlled by DTMF signals, in order to remotely control the divert facility. In addition, the invention eliminates the need to determine, for example, with the network operator, the permission of the owner of the subscription for diversion.

Significant advantages are gained by using the invention, compared to the prior art. Communication can now be easily diverted from a forgotten/lost device to another device.

Other characteristic features of the invention will become apparent from the accompanying Claims while additional advantages that can be gained are itemized in the description portion.

In the following, the invention, which is not restricted to the embodiments disclosed in the following, is examined in greater detail with reference to the accompanying drawings, in which

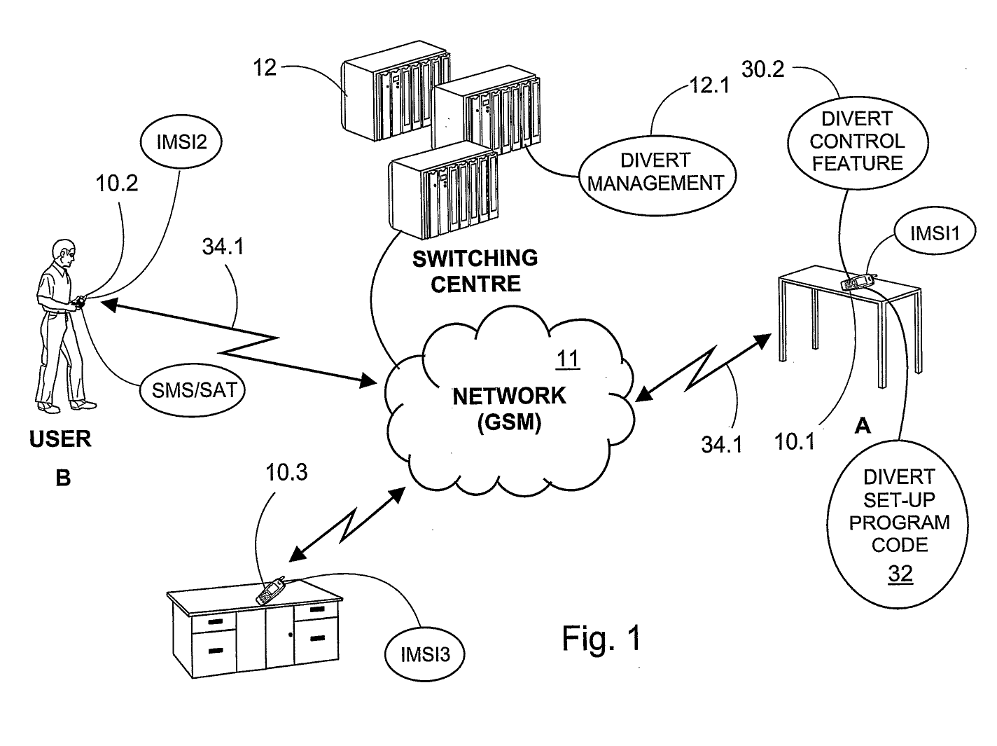

FIG. 1 shows one example of the system according to the invention,

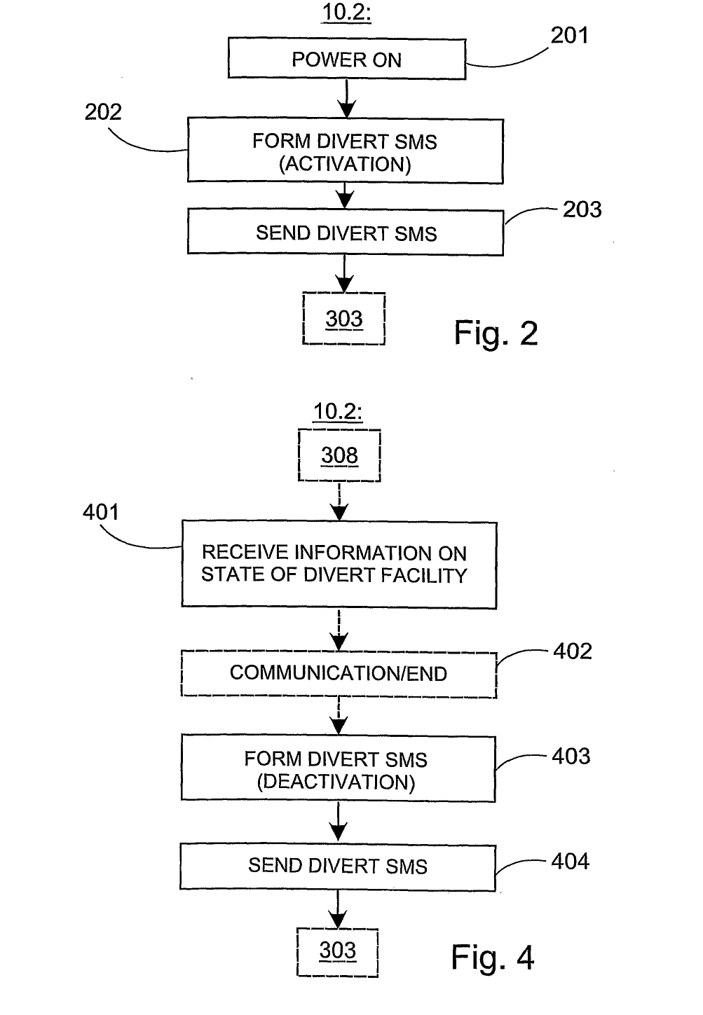

FIGS. 2-5 show a flow diagram of one example of the method according to the invention,

FIGS. 6a and 6b show some examples of data messages according to the invention,

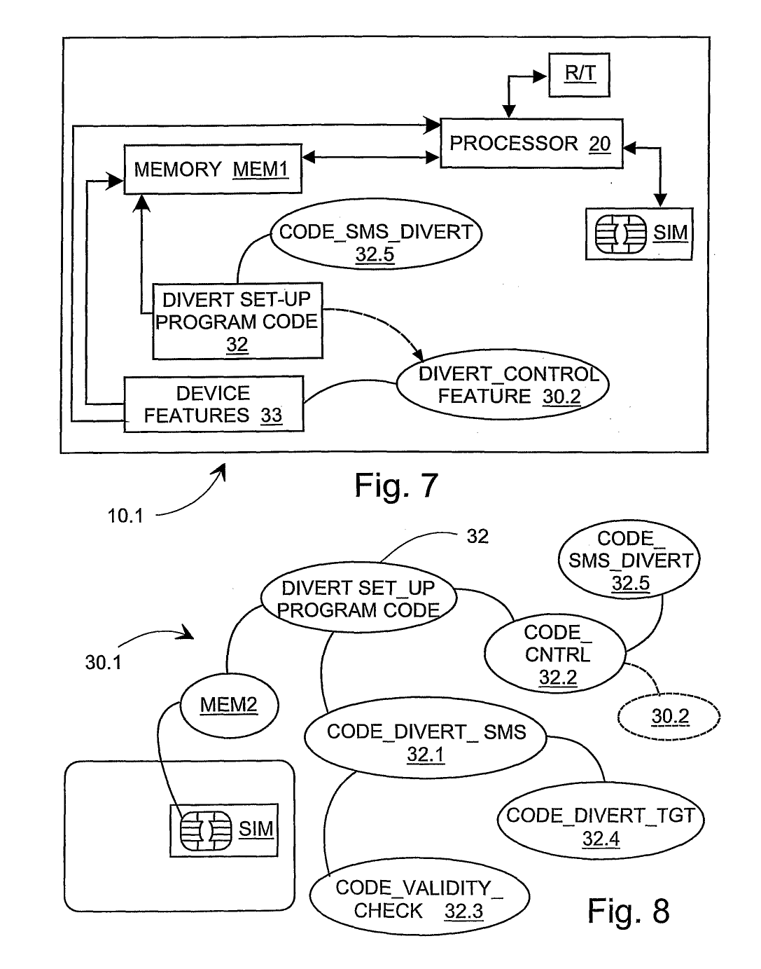

FIG. 7 shows a rough block diagram of one example of the wireless communication device according to the invention, and

FIG. 8 shows one example of a subscriber identity module that can be fitted to a wireless communication device according to the invention.

FIG. 1 shows one example of a system, to which the invention can be applied. In this case, the system is formed of a wireless data communication network 11 and wireless communication devices 10.1-10.3 communicating in it. The communication devices can be, for example, mobile stations 10.1-10.3, which can communicate with each other in a manner that is, as such, known, through the wireless data communication network 11. The data communication network 11 can be, as such, known, or wireless network that is presently only being developed. The data communication network 11 can also be formed of several network systems that are connected to each other.

The data communication network 11 includes network components 12 that are, as such known, for permitting communication and for transmitting them between the communicating communication devices 10.1-10.3. In this connection, there is no need to describe these components 12 in greater detail, as in terms of the invention they may even be, as such, known to one versed in the art. The functionality that is the really essential feature of the data communication network 11 in terms of the invention, is the divert facility 12.1, which is, as such, known. The divert facility can also be implemented partly even in the communication devices 10.1-10.3, which embodiment is described later in greater detail.

The divert facility 12.1, or forward facility, call redirection depending on which choice of terms it is wished to use, can be activated or deactivated concerning the selected communication devices 10.1-10.3. At a more general level, the divert facility 12.1 concerning at least one mobile station 10.1 communicating in the data communication network 11 can be managed. In that case, communication from the other communication devices 10.2, 10.3 in the data communication network 11, addressed to the mobile station 10.1 in question, are guided instead by the network component 12.1 to another communication device 10.2, 10.3 communicating in the wireless data communication network 11. On the other hand, the communication may also be guided to landline network. This device, which is also referred to as the destination communication device 10.2, 10.3, can be defined in connection with setting the divert facility 12.1. The operation of the network component 12.1 of the divert facility 12 is completely known among the man skilled in the art and no more descriptions relating to this matter are needed in this connection.

The operations relating to the divert facility can be performed from, besides the network 11, or even instead of it, at least from some of the mobile stations 10.1-10.3, only provided they are equipped with suitable forwarding functionalities 32.5. An example of an application relating to this will be disclosed later in greater detail.

In this case, the performing of operations relating to the divert facility can be understood very widely and the basic principle of the invention doesn't limit that any way. It can be, for example, the activation or deactivation of the facility, the resetting of the facility, or even the responding to its state-data queries. For these operations, the data communication network 11 includes means 12 and functionalities 12.1 for performing the operations relating to the divert facility. The means can be formed of a processor functionality 12 belonging to a network element that is, as such, known, in which the application 12.1 managing the divert facility is executed. On the other hand, the means or functionalities corresponding to them can also be arranged at least partly in the communication devices 10.1-10.3, as stated above and disclosed in greater detail later.

In the data communication network 11, several mobile stations 10.1-10.3, such as at least two mobile stations 10.1, 10.2, can communicate with each other. In that case, the communication devices 10.1-10.3 include means R/T for performing wireless communication in the data communication network 11. These means can include a wireless transmitter/receiver unit R/T, together with their closely related facilities.

The mobile stations 10.1-10.3 are equipped with special identifiers, with the aid of which they can be individually identified in the network system 11. The identifiers can be, for example, mobile communication subscriber identifiers, which are also known under the IMSI acronym (International Mobile Subscriber Identification).

At least one such identifier IMSI1 can be associated with each communication device 10.1. On the other hand, in certain embodiments, such a case can also be considered, in which at least one identifier can be associated with several communication devices 10.1-10.3. In that case, communication addressed to the identifier can be routed to several devices 10.1-10.3. In the case of a voice call, for example, the first of these communication devices 10.1-10.3 to be able to respond to a connection-formation request will take possession of the connection. In the case of a data message, for example, in text messaging, the message can be transmitted to all of the communication devices 10.1-10.3 as a group message.

Further in addition to the above, such a case may also be possible, in which several identifiers are associated with one or more devices. In that case, the communication addressed to these identifiers are routed to the same device, or to a group of devices defined by the identifiers. In terms of the present invention itself, the possible identifier/communication device connection combinations are of no great significance, so that numerous different alternatives can be considered.

FIG. 7 shows a very rough block diagram presentation of one example of a wireless communication device 10.1 according to the invention. The divert facility 12.1 of communication addressed from the data communication network 11 to at least the device 10.1 itself can be managed in a manner that is, as such, known from at least some of the communication devices 10.1 communicating in the data communication network 11. In order to this the device 10.1 is equipped with the control feature of the divert facility 30.2 known as such. In order to control the divert facility 12.1, a communication device 10.2 can be used to perform, for example, a set-form of control code series that is, as such, of a known kind. For example, the device identifier/identifiers IMSI2, to which it is desired to route the set parts of communication addressed from the data communication network 11 to at least this relevant communication device 10.1 managing its own divert facility, may be attached to the control code series.

According to one first embodiment, the control code series and the identifier IMSI2 of the desired destination device 10.2 can be virtually ‘written’ using the numerical keypad of the communication device 10.1. In this case the reference may be made to so called “21-divert”. The control command, which is formed virtually, can then be sent, using the device 10.1, to the management application 12.1 of the divert facility arranged in the data communication network 11. One example of this kind of code series activating the divert facility could be “**21*+country code, area code, phone number # [handset]”. From the user's point of view, this operation would correspond, except for the writing of the control codes, very largely to a voice-call connection formation attempt, that is, as such, known. Correspondingly, the divert facility may be switched off, for example, by using the code series “##21# [handset]”. Here the [handset] means the pressing of the Call-button that is in the most cases the same by using of which, for example, the call is initialized or the selection is activated. For the man skilled in the art it is apparent that the control code series may vary, for example, by operator/service provider specific or by network system specific. In general, the format of the control code series has no crucial meaning in the light of the invention.

According to a second embodiment, the divert facility 12.1 can also be managed using, as such, well-known and well-defined control feature of the divert facility 30.2 arranged in the device functions 33 of the communication device 10.1. The “21-divert” may also be understood as such control feature. In that case, the performance of the operation will not require the user, for example, to have any particular expertise/knowledge relating to control codes. The user can activate the feature/application 30.2 controlling the divert from a user-interface menu of the communication device 10.1. It can be used to define, for example, the type of the desired divert or other settings relating to the divert and to enter the destination identifier IMSI2, to which it is wished to make the divert. In general, these settings relating to the divert are well-known among the man skilled in the art and those don't limit in any way the applicability of the invention to different kind of diverts. The control feature of the divert facility 30.2 will automatically add these control codes to the identifier IMSI2 given by the user, in the correct sequence according to the selected type of divert. After the final acknowledgement from the user, (for example the key-press of the handset button) transmission of the message controlling the divert facility 12.1 is performed to the network system automatically by the communication device 10.1. For the user this usually seems as a message “divert activation” on the display of the device 10.1.

According to a first embodiment of the invention, the control feature of the divert facility 30.2 of the communication device 10.1 can be managed, in a very surprising manner, by remote control. According to a first embodiment, the remote management can be performed using a set-form of data message 13.1, 13.2 sent from a second communication device 10.2. The data message can be received by the communication device 10.1 and, on its basis, for example, it is possible by remote control to manage the control feature of the divert facility 30.2 described above, by means of which the divert facility concerning the device 10.1 itself are then managed onwards by using the well-known and, for example, the practises presented just above.

For this purpose, at least some of the communication devices 10.1 communicating in the data communication network 11 can include means 20, 32 arranged to operate in a set manner in connection with them, in order to manage the control feature of the divert facility 30.2 and in turn the divert facility 12.1, 32.5 using the communication device 10.1. According to a first embodiment, these means can include a processor 20 in the communication device 10.1 itself. The processor 20 can be used to run a group of, for example, program commands, set in a preset sequence. The commands can be combined to form a single modular totality, for example, the program product 30.1 according to the invention.

The program product 30.1 can be arranged in a memory medium MEM1 arranged in connection with the communication device 10.1. One example of this is a non-volatile updatable semiconductor memory, which is widely used in mobile stations for storing data and applications. The program product 30.1 includes a set of program codes 32.1-32.5, which are written on this storage medium MEM1 and by means of which the control feature of the divert facility 30.2 of the communication device 10.1 can be managed by remote control. The program product 30.1 can be updated in set parts, for example, in a set manner over the network 11. It can be, for example, JAVA code, which can be performed by the virtual processor run in the communication device 10.1.

The program product 30.1 according to the invention can, on the other hand, also be arranged in the subscriber identity module arranged in connection with the communication device 10.1, such as a SIM card SIM (FIG. 8). In that case, the SIM card SIM, which is otherwise of a known type, also has a memory MEM2, for storing the program code 32, as well as possible processor means, for performing the program code 32.

With reference to the embodiment of FIG. 8, the program code 32 is used to interpret the data messages 13.1, 13.2 received by the communication device 10.1. From the received data messages 13.1, 13.2, one or more set syntaxes are sought. For this purpose, the program code 32 includes code means 32.1, which are configured to interpret whether the data message 13.1, 13.2 received by the communication device 10.1 meets the criteria set for data messages set to manage the control feature of the divert facility 30.2, or whether the data message is even in general intended for controlling the control feature of the divert facility 30.2. In addition, the program code 32 also includes second code means 32.2. These are configured to control the control feature of the divert facility 30.2 being in the device 10.1 according to the data message 13.1, 13.2 received by the device 10.1.

If the data message 13.1, 13.2 is in all ways valid, then the program code 32 will manage the feature 30.2 controlling the divert facility 12.1 of the communication device 10.1. The control feature of the divert facility 30.2 in the device 10.1 in turn sends a set-form of data message to the set-up functionality facility 12.1 of the divert facility arranged in the data communication network 11. It directs the communication addressed to the device 10.1 in an established parts to the target device 10.2 in a manner known as such.

One example of such a data message, by means of which the control feature of the divert facility 30.2 of the device 10.1 can be remotely controlled, is an SMS message 13.1, 13.2, i.e. a text message. Application of the other data messages and control signals may also become to question (for example, USSD message, Unstructured Supplementary Service Data). The form, i.e. syntax, of the SMS message performing the management can be defined in several different ways. What is most important, however, is that the syntax conforms to that set, so that remote control can be performed explicitly.

The SMS message 13.1, 13.2 is received by the communication device 10.2 from the data communication network 11. The SMS message 13.1, 13.2 will have been sent, for example, by some second communication device 10.2, 10.3 communicating on the data communication network 11, which message 13.1, 13.2 the data communication network 11 then relays to the communication device 10.1 in question, which receives it. In order to form the SMS message 13.1, 13.2, the remote controlling devices 10.1-10.3 can have in them already an application, in which there is ready a possibility to enter divert settings data according to the syntax. One example of this is the SAT application (Sim Application Toolkit). In that case, the sender of the divert message 13.1, 13.2 need not necessary remember the correct syntax for the control message, instead the device 10.1-10.3 performs the configuration required for this, once it has received the correct input data from the user USER.

On the other hand, the transmission of the message 13.1, 13.2 can also be performed, for example, using a PC computer, or a similar electronic device, by means of which in some way it is possible to communicate with the relevant communication device 10.1.

FIGS. 6a and 6b show some examples of SMS messages 13.1, 13.2 according to the invention. In order be able to use the SMS message 13.1, 13.2 to manage the state of the divert facility 12.1 of the communication device 10.1 that is the message's target, it must thus be according to the set syntax. Generally, the SMS message 13.1, 13.2 can form from settings data according to the set-form.

According to one first embodiment, this settings data can include authentication data 16. In order to detect the authentication data 16, the program code 32 additionally includes code means 32.3 configured to detect this authentication data 16 from the data message 13.1, 13.2 (FIG. 8).

On the basis of the authentication data 16, the validity of the SMS message 13.1, 13.2 received by the program code 32 can be ensured in connection with the communication device 10.1. Even more particularly, the validity check can also be made in relation to the setting of the control feature of the divert facility 30.2 defined in the SMS message 13.1, 13.2. One example of this is an authorization check, i.e. whether the sender USER of the divert SMS message 13.1, 13.2 is authorized to make precisely the divert setting that is defined in the SMS message 13.1, 13.2.

According to one second embodiment, identifier data IMSI2, IMSI3 can belong in connection with the SMS message 13.1, as settings data. For this purpose, the program code 32 can include code means 32.4, configured to detect the identifier data IMSI2, IMSI3 from the SMS message 13.1, as settings data (FIG. 8). On the basis of the identifier data IMSI2, IMSI3, the receiving communication device 10.1 can perform the set measures, relating to the divert facility targeted to it (code mean 32.4). Some examples of those include to activation/deactivation of the divert facility to one or more communication devices 10.2, 10.3 defined by the identifier data IMSI2, IMSI3. In addition, the identifier data IMSI2, IMSI3 can also be used in connection with the validity check already referred to above, for example, when deciding the settings rights of the divert facility.

As in the embodiment according to FIG. 6b, the identifier data IMSI1 can already be in the header data 14.1 of the SMS message 13.1, which can be understood as the subscriber identifier IMSI2 of the user's USER communication device 10.2. Such an embodiment is possible, if the party USER sending the divert facility data message 13.1 to the communication device 10.1 used, to send the message 13.2, the communication device 10.2, to which they wish the set parts of the communication addressed to the communication device 10.1, which is the object of the setting of the divert facility, to be sent.

According to the embodiment shown in FIG. 6a, the identifier data IMSI3 can also be in the actual SMS message 13.1, at the location 14.2 defined by its syntax. Such an embodiment can be considered, for example, when it is not wished to send, the set parts of the communication addressed to the communication device 10.1 that is the object of the divert facility, to the device 10.2, by means of which the divert facility data message 13.1 was sent, but instead to some other third device 10.3, the identifier IMSI3 of which is thus now defined in the SMS message 13.1.

In addition to the above, there can also be other settings data 17 in the SMS message 13.1, 13.2, in a manner permitted by its syntax. Some examples of such data are the type 17 of the divert facility 12.1, for example, what kind of communication it is wished to set the divert facility to apply to (call/data/fax), or various kinds of time settings relating to the divert facility, for example, when the divert facility will be defined to be active, will the divert take place possible immediately (full divert) or delayed (delay divert) or only, if the called number is busy (busy divert). In addition, the one in question may also become, for example, parameter definitions relating to various state-data queries of the divert facility.

On the basis of the above fixed-form data message 13.1, 13.2, the invention also applies to a signal 34.1 transmitted in the data communication network 11, for managing the control feature of the divert facility 30.2 of the communication device 10.1 and, as a result, the divert facility of the device 10.1 itself. In a manner that is, as such, known, a set-form data message according to the invention, for example, an SMS message 13.1, 13.2 can be adapted to the signal 34.1. On the basis of the SMS message 13.1, 13.2, the control feature of the divert facility 30.2 and as a result of that, the divert facility of the receiving communication device 10.1 can be managed, by using remote controlled manner in set parts, using other established communication devices 10.2, 10.3 belonging to the data communication network 11.

In the following, the method according to the invention is described as one embodiment shown in the flow diagrams in FIGS. 2-5 and with reference to the system shown in FIG. 1. The method permits the management of communication addressed to the communication device 10.1 in the data communication network 11, in a surprising manner by remotely controlled.

The situation in FIG. 1 can be one in which the user USER has accidentally left at home A the actual mobile station 10.1 that they generally use. This mobile station 10.1 is equipped with at least one identifier IMS1 that identifies it explicitly in the data communication network 11. At their workplace B, the user USER is given one of their company's group data phones 10.2, which is equipped with the identifier IMSI2.

FIG. 2 shows the operations on the device 10.2, from which the method description according to the invention can be itemized. The device 10.2 is naturally in a stand-by state, so that it can be used to communicate in the data communication network 11 (stage 201).

In stage 202, the user USER uses the device 10.2 to form an SMS message 13.1, 13.2 according to the set syntax. If the user USER remembers the syntax required for an SMS message 13.1, 13.2 according to the invention, they can perform the formation of the message as such conventionally in the SMS section SMS of the device 10.1. If the device 10.2 is equipped with a SIM card SIM, in which a suitable application for forming an SMS message 13.1, 13.2 according to the invention is ready implemented, for example, being a SAT application, the user USER can then enter the data required by the SMS message 13.1, 13.2 through this application.

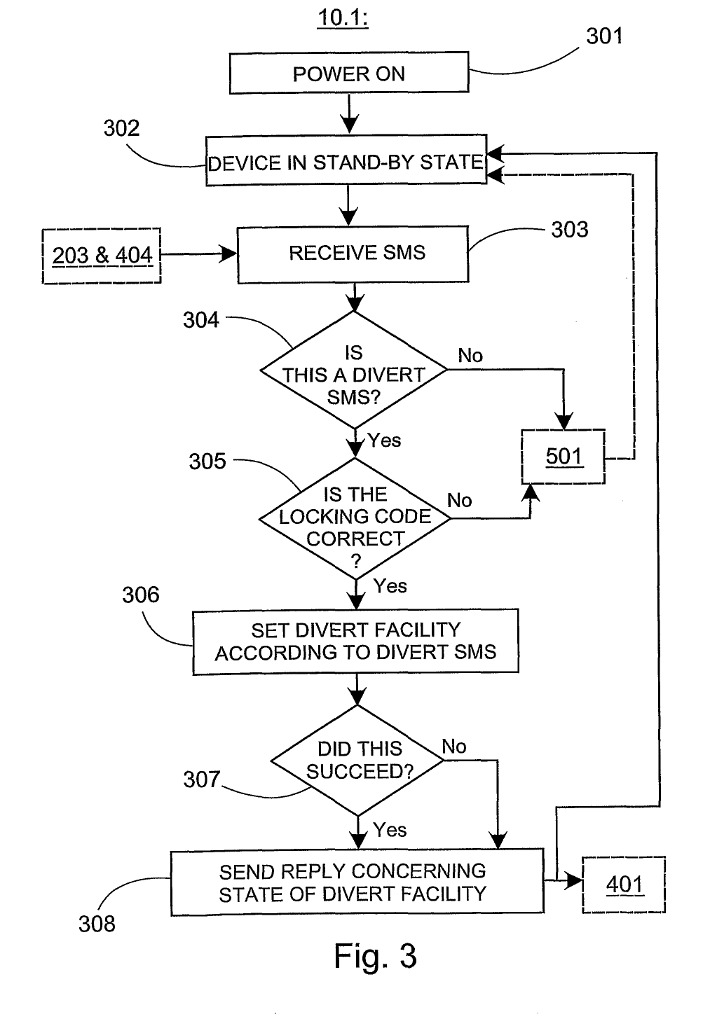

In stage 203, the user sends, using the device 10.2, the SMS message 13.1, 13.2 that they have formed through the data communication network 11 to the device 10.1 at home A. From this stage, the method moves to part stage 303 of FIG. 3.

FIG. 3 shows the method on the remotely controllable communication device 10.1. In this embodiment, what is essential in terms of the invention is that this device 10.1, which is remotely controlled according to the invention, is switched on and that the device is thus in a stand-by state (stages 301 and 302). Thus, the device 10.1 can receive traffic relayed to it from the data communication network 11.

In stage 303, the device 10.1 receives an SMS message. If the program code 32 forms part of the device 10.1, and even more particularly, if it is presently activated in the device 10.1, then when the device 10.1 receives the message 13.1, 13.2, the code means 32.1 initially check whether it this is only a normal SMS message, or a set-form data message 13.1, 13.2 according to the invention (stage 304).

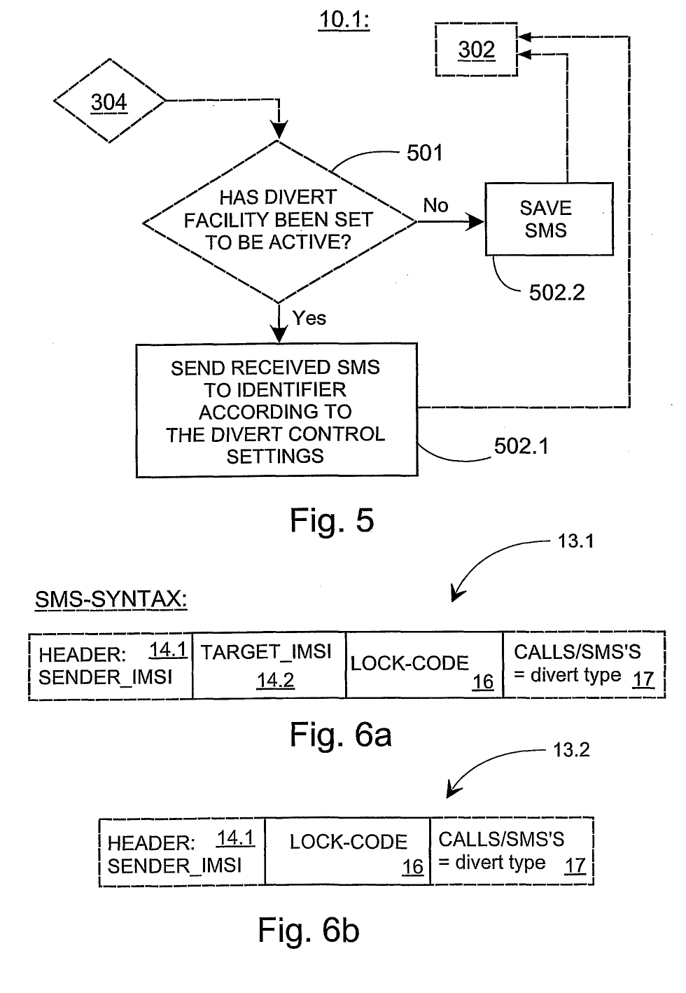

If the message is a conventional SMS message, the next move is to the flowchart portion shown in FIG. 5 and to stage 501 in it, which is examined later in greater detail. If it is an SMS message 13.1, 13.2 controlling the control feature of the divert facility 30.2, the next move is to stage 305.

In stage 305, the code means 32.3 of the program code 32 check the validity of the SMS message 13.1, 13.2 and the remote controlling at the same time. The SMS message 13.1, 13.2 includes settings data, from which the authentication data 16 is detected. On the basis of this, a decision is made as to the validity of the controlling of the control feature of the divert facility 30.2 and the settings objected to it defined by the SMS message 13.1, 13.2. If some problem arises in the validity of the SMS message 13.1, 13.2 (for example, it is wrong), a move is made, for example, to stage 501. As a result of this the SMS-message 13.1, 13.2 is processed in a way like conventional SMS-message and the user of the device 10.1 may see that from which identification was tried this kind of unjustifiable disturbance divert. The justified user USER may conclude a failure of the divert, for example, about that there will be never terminated to stage 308 and as a result of that there will also not received a response to the state of the divert in a reasonable time (for example, in a couple of minutes after stage 203). If the validity of the SMS message 13.1, 13.2 is correct, a move can be made to the following stage 306.

Once the validity of the SMS message 13.1, 13.2 has been checked in stage 305 and determined to be correct, then next in stage 306 the control feature of the divert facility 30.2 concerning the communication device 10.1 can be managed, according to the settings data 16, 14.1, 14.2, 17 being in the SMS message 13.1, 13.2.

In the case, the code means 32.4 are used to detect from the SMS message 13.1 the identifier data IMSI2, IMSI3, on the basis of which the divert facility is activated, in the one or more communication devices 10.2, 10.3 defined by the identifier data IMSI2, IMSI3.

As a result of this, the device 10.1 forms, for example, with the aid of the control feature 30.2 in it, a divert facility 12.1 activation control command, which the device 10.1 then sends to the data communication network system 11. The management application 12.1 of the divert facility of the data communication network 11 then, in a manner that is, as such, known, activates the divert facility concerning the device 10.1 itself, when the communication addressed to the communication device 10.1 defined by the identifier IMSI1 is routed in the set manner at least partly to the communication device 10.2 defined by the second identifier IMSI2.

In stage 307, a check is made as to whether the setting of the divert facility 12.1 succeeded. If the setting of the divert facility 12.1 succeeded or, for some reason, failed (regardless of the valid locking code), then in stage 308 a message concerning the state of the setting is sent to the device 10.2 that controlled remotely the control feature of the divert facility 30.2. After this, the device 10.1 can return to its stand-by state 302, the communication addressed to it being, however, still routed in set parts to the set identifier IMSI2, as a result of the control operations performed above.

In stage 401, shown in FIG. 4, the user USER receives with the device 10.2 information on the state of the divert facility concerning the device 10.1 that was forgotten at home. If the state message is not received in a reasonable time window, a conclusion may be performed that in the validation of the user USER (stage 305), or in the success of the setting of the divert facility has been arisen problems (for example, the device 10.1 switched off due to the low power). As a result of this, the user USER can make the necessary investigations. If it is only a case of a keying-in error, the user USER then may return to stage 202, in which the divert-SMS message 13.1, 13.2 is formed again.

If everything takes place successfully, then in stage 402 the user USER can perform communication using the device 10.2 instead of the device 10.1. The data communication network 11 and the divert function 12.1 arranged to that then routes the set parts of the communication intended for the device 10.1 to the device 10.2.

Next, when the user USER wishes, for example, to deactivate the divert facility 12.1, they can also perform it by remote control using the borrow device 10.2. In stage 403, an SMS deactivation message 13.1, 13.2 with the required form of syntax is formed. The deactivation of the facility 12.1 can be stated, for example, in the additional-data field 17 of the SMS message. In stage 404, the message 13.1, 13.2 initiating the deactivation procedure for the facility 12.1 is sent by using the device 10.2.

The deactivation of the facility 12.1 and the related exceptional situation processing can be performed mainly in manner corresponding to that for its activation in stages 302-308. If all of the aspects relating to the deactivation procedure went correctly, in stage 308 an SMS message of the successful deactivation of the facility 12.1 is sent to the device 10.2. In stage 401, the message is received and the entire activation/deactivation procedure terminates in stage 402 (END). Again, if the deactivation's confirmation message will never be received, such a conclusion may be performed that there were some problems in the deactivation.

Next, a return is made to the part stage 304 shown in FIG. 3. If the SMS message received by the device 10.1 in stage 303 is a normal SMS message the procedure moves to stage 501 shown in FIG. 5. In stage 501, the code means of the device 10.1 are used to check whether the divert facility 32.5 is active in the case of SMS messages. If the divert facility 32.5 concerning the SMS-messages is not active, in stage 502.2 the received SMS message is stored in the device 10.1 in a known manner and a return is made to the stand-by state in stage 302.

Instead, if in the case of SMS messages the divert facility 32.5 is active, then in stage 502.1 the SMS message addressed to and received by the communication device 10.1 is rerouted, i.e. forwarded in a manner defined by the divert facility data message 13.1, 13.2 to the device 10.2 defined in the settings. Also after this it is possible to return in the device 10.1 to the stand-by state according to stage 302.

Thus, the SMS relaying functionality 32.5 can be, instead of in the data communication network 11, in the device 10.1 itself, which then forwards the SMS-message through the network 11 to the destination device 10.2. This takes place particularly in the case if the operator has not provided in a network 11 the SMS divert functionality. On the other hand, it is naturally possible to arrange the relaying/divert/reroute functionality also even in the device 12.1 itself also in the case of phone calls. A data transmission functionality can also be arranged in the network system 11, in a corresponding manner to phone call rerouting. In that case, the device 10.1 need not even be switched on.

In order to implement the SMS divert facility, at least some of the communication devices 10.1 can include means 32.5, by means of which it is possible to route data communication addressed to the communication device 10.1 forward in a manner defined by the divert facility data message 13.1, 13.2. Such a data communication can include, for example, SMS messages, MMS messages, and in general all kinds of data being transmitted through the data communication network 11. The SMS divert facility 32.5 can be implemented in the program product 30.1, of which program code 32 includes program code means 32.5 configured to process SMS communication addressed to the communication device 10.1, in a manner defined in an SMS message 13.1, 13.2 controlling the control feature of the divert facility 30.2 according to the invention. Here the processing may be understood, for example, as a forwarding of the data message to the established identification.

The use of the data communication diversion functionality achieves an advantage that is now not, for example, dependent on the rerouting services provided by the operators. This is because not all operators namely even permit a data communication divert facility, even though there may not be any network technology obstacles to this, or at least any possible obstacles could be quite easily resolved.

Further, the remote controlling of the divert facility 12.1 can also be implemented in such a way that the settings functions of the divert facility 12.1 are performed partly in the device 10.1 and partly in the network system 11, for example, in connection with the network component 12 managing the divert facility 12.1. In that case the data message 13.1, 13.2, which can also now be understood in a specific manner as a service message, can be addressed, instead of or besides to the device 10.1 being controlled, directly to this network component (switching centre or base station) 12, which will perform the settings corresponding to it. The use of rerouting of communication performed as this kind of operator service will achieve, for instance, the advantage that remote control can be performed in that case too, even though the forgotten device 10.1 at home A would be switched off.

Further, in order to remotely control the divert facility 12.1, it is possible to apply various kinds of automatic robot voice services or dial tone codes (DTMF applications), instead of a data message 13.1, 13.2. These can be arranged, for example, in the communication device 10.1-10.3, or in the network system 11.

It must be understood that the above description and the related figures are only intended to illustrate the present invention. The invention is thus in no way restricted to only the embodiments disclosed or stated in the Claims, but many different variations and adaptations of the invention, which are possible within the scope on the inventive idea defined in the accompanying Claims, will be obvious to one versed in the art.

1. A method for managing, in a data communication network, communication addressed to a wireless communication device, in which the wireless communication devices communicating in the data communication network are equipped with at least one identifier (IMSI1-IMSI3) and in which, the communication device is equipped with a control feature of a divert facility, in order to control the divert facility concerning itself, and in which communication addressed to at least one communication device defined by a first identifier/identifiers (IMSI1) is routed at least partly to at least one communication device defined by a second identifier/identifiers (IMSI2), characterized in that the control feature of the divert facility of the communication device defined by the first identifier/identifiers (IMSI1) is remotely controlled using some second communication device.

2. A method according to claim 1, characterized in that the second communication device is used to send a data message, on the basis of which the control feature of the divert facility is remote controlled (stage 203).

3. A method according to claim 1, characterized in that the data message includes authentication data, on the basis of which the validity of the remote controlling is decided (stages 304, 305).

4. A method according to claim 1, characterized in that the data message includes identifier data (IMSI2, IMSI3), on the basis of which the divert facility is activated/deactivated to one or more communication devices defined by the identifier data (IMSI2, IMSI3).

5. A method according to claim 4, characterized in that the identifier data (IMSI2) is identified from the sender data of a data message, to which the communication are routed in a set manner.

6. A method according to any of claim 2, characterized in that the data message is transmitted to the communication device defined by the first identifier/identifiers (IMSI1), which manages the divert facility concerning itself.

7. A method according to any of claim 2, characterized in that, when the divert facility concerns the data communication addressed to the communication device, the data message is processed in a manner defined by the divert facility data message (stages 501, 502.1).

8. A wireless communication device, which includes means (R/T) for performing communication in the data communication network, in which several communication devices equipped with at least one identifier (IMSI1-IMSI3) can communicate, and in which at least in some of the wireless communication devices is a control feature of a divert facility, in order to route communication addressed to at least one communication device defined by a first identifier/identifiers (IMSI1) at least partly to at least one communication device defined by a second identifier/identifiers (IMSI2), characterized in that the control feature of the divert facility is remote controllable.

9. A communication device according to claim 8, characterized in that the remote controlling is arranged to take place on the basis of a set-form data message, which is arranged to be received by the communication device from the data communication network.

10. A communication device according to claim 9, characterized in that the data message, includes authentication data, on the basis of which the validity of the remote controlling defined by the data message is arranged to be ensured.

11. A communication device according to claim 9, characterized in that the data message has in connection with it identifier data (IMSI2, IMSI3), on the basis of which the communication device is arranged to activate/deactivate the divert facility to one or more communication devices (10.2, 10.3) defined by the identifier data (IMSI2, IMSI3).

12. A communication device according to claim 9, characterized in that the communication device includes means, which are arranged to process the data communication addressed to the communication device, in the manner defined by the divert facility data message.

13. A system for managing a control feature of a divert facility of a wireless communication device in a data communication network, which system includes
at least one wireless communication device equipped with a first identifier/identifiers (IMSI1) and a control feature of a divert facility concerning itself,
at least one wireless communication device equipped with a second identifier/identifiers (IMSI2, IMSI3), to which at least an established part of the communication addressed to the said communication device equipped with a first identifier/identifiers (IMSI1) may be routed, and
means belonging to the data communication network for implementing the operations relating to the divert facility,
characterized in that the control feature of the divert facility of the communication device defined by the first identifier/identifiers (IMSI1) is arranged to be remotely controlled by means of some second communication device communicating in the data communication network.

14. A system according to claim 13, characterized in that the remote control is arranged to be performed on the basis of a set-form data message

15. A system according to claim 14, characterized in that the data message is arranged to be interpreted in the communication device.

16. A system according to any of claim 14, characterized in that at least some of the communication devices include means for forwarding at least data communication in a manner defined by the data message remote controlling the control feature of the divert facility.

17. A program product for managing a control feature of a divert facility of the wireless communication device, which program product includes storage media (MEM1, MEM2) and program code (written on the storage media (MEM1, MEM2) for managing the control feature of the divert facility of the wireless communication device, and in which by the control feature of the divert facility the communication from the data communication network addressed to the communication device can be set to be routed at least partly to at least one second set communication device in the data communication network, characterized in that, the program code includes
a first code means configured to interpret whether a data message received by the communication device meets the criteria set for data message set to manage the control feature of the divert facility, and
a second code means configured to control the control feature of the divert facility according to the said data message.

18. A program product according to claim 17, characterized in that the program code includes in addition third code means configured to detect settings data, including authentication data, from the data message, on the basis of which the third code means is configured to determine the validity of the remote controlling.

19. A program product according to claim 17, characterized in that the program code includes in addition fourth code means configured to detect identifier data (IMSI2, IMSI3) as settings data from the data message, on the basis of which the fourth code means is configured to target operations to the divert set-up function relating to one or more communication devices defined by the identifier data (IMSI2, IMSI3).

20. A program product according to claim 17, characterized in that the program product includes in addition fifth code means configured to process data communication addressed to the communication device in a manner defined by the divert facility data message.

21. A subscriber identity module (SIM) to be fitted to a wireless communication device, characterized in that it has arranged in it a program code according to any of claim 17.

22. A signal for managing a control feature of a divert facility of a wireless communication device in a data communication network, in which communication addressed to at least one wireless communication device equipped with a first identifier/identifiers (IMSI1) is arranged to be routed at least partly to at least one second communication device equipped with a second identifier/identifiers (IMSI2, IMSI3), and the divert facility of the communication device equipped with the first identifier/identifiers (IMSI1) is arranged to be controlled by the control feature of the divert facility arranged to the communication device, characterized in that a set-form data message is arranged in the signal, on the basis of which the control feature of the divert facility is arranged to be remotely controlled.

23. A signal according to claim 22, characterized in that the data message includes settings data, including particularly authentication data, on the basis of which the validity of the remote controlling is arranged to be ensured.

24. A signal according to claim 22, characterized in that in connection with the data message arranged in the signal there are, as settings data, identifier data (IMSI2, IMSI3), on the basis of which the divert facility is arranged to be activated/deactivated in one or more communication devices defined by the identifier data (IMSI2, IMSI3).
